(19) United States
(12) Patent Application Publication
(10) Pub. No.: US 2017/0264930 A1
(43) Pub. Date: Sep. 14, 2017

(54) METHOD AND SYSTEM OF STANDARDIZING MEDIA CONTENT FOR CHANNEL AGNOSTIC DETECTION OF TELEVISION ADVERTISEMENTS

(71) Applicant: Silveredge Technologies Pvt. Ltd., Gurgaon (IN)

(72) Inventors: Debasish MITRA, Gurgaon (IN); Hitesh CHAWLA, Gurgaon (IN)

(21) Appl. No.: 15/454,770

(22) Filed: Mar. 9, 2017

(30) Foreign Application Priority Data
Mar. 9, 2016 (IN) 201611008281

(51) Int. Cl. H04N 21/24; H04N 21/237; H04N 21/81; H04N 21/488

(52) U.S. Cl. CPC H04N 21/2407; H04N 21/4886; H04N 21/237; H04N 21/812

(57) ABSTRACT

A system and method for standardizing media content for channel agnostic detection of television advertisements includes normalizing each frame of a video corresponding to broadcast media content on the channel. The method also includes deriving one or more characteristics corresponding to one or more features. The method also includes trimming a pre-defined percentage of area in each frame of the media content based on the one or more characteristics corresponding to the one or more features associated with the media content. The method also includes extracting a first set of audio fingerprints and a first set of video fingerprints. The first set of audio fingerprints and the first set of video fingerprints correspond to a media content broadcasting on the channel. The method also includes detecting the one or more advertisements broadcast across the plurality of channels in the real time.

### INTRODUCTION

The present invention relates to the field of digital fingerprinting of media content and, in particular, relates to standardizing of media content for channel agnostic detection of television advertisements.

Over the last few years, many new television channels have been launched. These television channels broadcast media content for the viewers. Each channel is differentiated or recognized by its own unique logo which makes it easy for the viewers to recognize the channel. In addition, some channels also contain tickers displayed dynamically in the real time during a television broadcast of the media content. The broadcasted media content is identified by its digital fingerprints. These digital fingerprints corresponds to the advertisements are different from the digital fingerprints extracted for the same advertisement broadcasted on the other channel. This difference in the digital fingerprints of the same advertisement broadcasted on different channels is due the presence or absence of different logos associated with each channel, presence or absence of tickers in the channels and the like. Owing to the mismatch in digital fingerprints of same advertisement across multiple channel results in troll detection of the same advertisement across multiple channels. This has created a need for standardization of media content for negating troll detection of same advertisements broadcasted across multiple channels.

These advertisements can be primarily detected through an unsupervised machine learning based approach and a supervised machine learning based approach. The unsupervised machine learning based approach focuses on detection of advertisements by extracting and analyzing digital fingerprints of each advertisement. Similarly, the supervised machine learning based approach focuses on mapping and matching digital fingerprints of each advertisement with a known set of digital fingerprints of corresponding advertisement.

Several systems and methods are currently available which perform detection of the advertisements broadcasted across the channels. In US Patent Publication No. 20060195859 a method and a system for specifying regions of interest for video event detection is presented. The method includes receiving a video stream and identifying a region of interest in a video stream. The region of interest is a portion of at least one image of the video stream. The region of interest in the video stream is analyzed to detect a video event in the region of interest.

In another U.S. Pat. No. 7,738,704 the method and the system for detecting a known video entity within a video stream is presented. The method includes receiving a video stream and continually creating statistical parameterized representations for windows of the video stream. The statistical parameterized representation windows are continually compared to windows of a plurality of fingerprints. Each of the plurality of fingerprints includes associated statistical parameterized representations of a known video entity. A known video entity in the video stream is detected when a particular fingerprint of the plurality of fingerprints has at least a threshold level of similarity with the video stream.

In yet another US Patent Publication No. 20140013352 the methods and the systems providing broadcast ad identification is presented. Methods include the steps of: providing fingerprint signatures of each frame in a broadcast video; and designating at least two repeat fingerprint signatures upon detecting at least one fingerprint-signature match from the signatures. Preferably, methods further includes a prior to the designating, determining whether the fingerprint signatures correspond to a known ad based upon detecting at least one fingerprint-signature match of the fingerprint signatures with pre-indexed fingerprint signatures of pre-indexed ads. Preferably, method further include: creating segments of the fingerprint signatures, ordered according to a timeline temporal proximity of the fingerprint signatures, by grouping at least two fingerprint signatures based on a repeat temporal proximity of at least two repeat fingerprint signatures respective of at least two fingerprint signatures. Preferably, methods further include detecting at least one ad candidate based on an occurrence of at least one repeat segment.

The present systems and methods have several disadvantages. In prior arts, the focus is on supervised detection of repeated advertisements. These prior arts extracts digital fingerprints without taking in consideration of the standardization of the media content broadcasted across the channels. In addition, these prior arts extract the digital fingerprints over the entire area of the frame including the media content broadcasted and the logos or tickers displayed on the channel. Furthermore, these prior arts do not take into account the accuracy of matching the digital fingerprints of the advertisement broadcasting on the different channels. Moreover, the present disclosure accurately extracts the digital fingerprints associated with the advertisement broadcasting across the channels. These methods and system are either not able to detect advertisements or imperfectly determine any new advertisements. In addition, these prior arts lack the precision and accuracy to differentiate programs from advertisements. These prior arts lack any approach and technique for unsupervised detection of any new advertisements.

In light of the above stated discussion, there is a need for a method and system which overcomes the above stated disadvantages.

### SUMMARY

In an aspect, the present disclosure provides a method for standardizing media content for channel agnostic detection of television advertisements in real time. The method includes a step of normalization of each frame of a video corresponding to broadcasted media content on the channel. The method includes another step of derivation of one or more characteristics corresponding to one or more features. The one or more features are associated with media content for each channel of the plurality of channels. The method includes yet another step of trimming of a pre-defined percentage of area in each frame of the media content. The trimming of the pre-defined percentage of area is performed based on the one or more characteristics corresponding to the one or more features associated with the media content. The method includes yet another step of extraction of a first set of audio fingerprints and a first set of video fingerprints. The first set of audio fingerprints and the first set of video fingerprints correspond to a media content broadcasting on the channel. The method includes yet another step of detection of the one or more advertisements broadcasted across the plurality of channels in the real time. The normalization of each frame is done based on histogram normalization and histogram equalization. Moreover, the normalization of each frame is done by adjusting luminous intensity value of each pixel to a desired luminous intensity value. The one or more features associated with the channel include a logo associated with the channel and a ticker associated with the channel. The first set of audio fingerprints and the first set of video fingerprints are extracted sequentially in the real time. Moreover, the extraction of the first set of video fingerprints is done by sequentially extracting one or more prominent fingerprints. The one or more prominent fingerprints corresponds to the one or more prominent frames of a pre-defined number of frames present in the media content for a pre-defined interval of broadcast. The one or more advertisements are detected based on at least one of a supervised detection and an unsupervised detection.

In an embodiment of the present disclosure, the one or more characteristics includes a first set of characteristics associated with a logo of the channel and a second set of characteristics associated with a ticker associated with the channel. The first set of characteristics includes a pre-defined height of the logo, a pre-defined width of the logo and a pre-defined position of the logo. In addition, the second set of characteristics includes a pre-defined height of the ticker, a pre-defined width of the ticker and a pre-defined position of the ticker.

In an embodiment of the present disclosure, the pre-defined percentage of area in each frame is trimmed to a pre-defined scale and wherein the pre-defined scale of each frame is 640×480.

In an embodiment of the present disclosure, the pre-defined percentage of area is 30%.

In an embodiment of the present disclosure, the method includes yet another step of generation of a set of digital signature values. The digital signature values correspond to an extracted set of video fingerprints. The generation of each digital signature value of the set of digital signature values is done by dividing each prominent frame of the one or more prominent frames into a pre-defined number of blocks. Further, each block of each prominent frame of the one or more prominent frames is gray scaled. Furthermore, the generation of each digital signature value of the set of digital signature values is done by calculating a first bit value and a second bit value for each block of the prominent frame. In addition, the generation of each digital signature value of the set of digital signature values is done by obtaining a 32 bit digital signature value corresponding to each prominent frame. Each block of the pre-defined number of block has a pre-defined number of pixels. The first bit value and the second bit value is calculated from comparison of a mean and a variance for the pre-defined number of pixels in each block of the prominent frame with a corresponding mean and variance for a master frame. The corresponding mean and variance for the master frame is present in the master database. The 32 bit digital signature value is obtained by sequentially arranging the first bit value and the second bit value for each block of the pre-defined number of blocks of the prominent frame.

In an embodiment of the present disclosure, the first bit value and the second bit value are assigned a binary 0 when the mean and the variance for each block of the prominent frame is less the corresponding mean and variance of each master frame.

In another embodiment of the present disclosure, the first bit value and the second bit value are assigned a binary 1 when the mean and the variance for each block of the prominent frame is greater than the corresponding mean and variance of each master frame.

In an embodiment of the present disclosure, the unsupervised detection of the one or more advertisements is done through one or more steps. The one or more steps includes a step of probabilistically matching a first pre-defined number of digital signature values of a real time broadcasted media content with a stored set of digital signature values present in the first database and the second database. The first pre-defined number of digital signature values corresponds to a pre-defined number of prominent frames. Further, the one or more steps include a step of a comparison of one or more prominent frequencies and one or more prominent amplitudes of an extracted first set of audio fingerprints. The one or more steps further include a step of determination of a positive probabilistic match of the pre-defined number of prominent frames based on a pre-defined condition. Furthermore, the one or more steps include a step of fetching of a video and an audio clip corresponding to a probabilistically matched digital signature values. The one or more steps further include a step of checking for presence of the audio and the video clip manually in the master database. In addition, the one or more steps includes a step of reporting a positively matched digital signature values corresponding to an advertisement of the one or more advertisement in a reporting database present in the first database. The probabilistic match is performed for the set of digital signature values by utilizing a temporal recurrence algorithm.

In an embodiment of the present disclosure, the pre-defined condition includes a pre-defined range of positive matches corresponding to probabilistically matched digital signature values, a pre-defined duration of media content corresponding to the positive match. In addition, the pre-defined condition includes a sequence and an order of the positive matches and a degree of positive match of a pre-defined range of number of bits of the first pre-defined number of signature values.

In an embodiment of the present disclosure, the method includes yet another step of storage of the one or more characteristics, the first set of audio fingerprints, the first set of video fingerprints and the set of digital signature values. In addition, the storage is done in a first database and a second database.

In an embodiment of the present disclosure, the method includes yet another step of updation of the one or more characteristics, the first set of audio fingerprints, the first set of video fingerprints and the set of digital signature values. In addition, the one or more characteristics, the first set of audio fingerprints, the first set of video fingerprints and the set of digital signature values detected are updated manually in a master database.

In an embodiment of the present disclosure, the supervised detection of the one or more advertisements is done through one or more steps. The one or more steps includes a step of probabilistically matching a second pre-defined number of digital signature values corresponding to a pre-defined number of prominent frames of a real time broadcasted media content with a stored set of digital signature values. The stored set of digital signature values is present in the master database. Further, the one or more steps includes a step of comparing the one or more prominent frequencies and the one or more prominent amplitudes corresponding to the extracted first set of audio fingerprints with a stored one or more prominent frequencies and a stored one or more prominent amplitudes. Furthermore, the one or more steps include a determination of the positive match in the probabilistically matching of the second pre-defined number of digital signature values with the stored set of digital signature values in the master database. In addition, the one or more steps includes a step of comparing the one or more prominent frequencies and the one or more prominent amplitudes corresponding to the extracted first set of audio fingerprints with the stored one or more prominent frequencies and the stored one or more prominent amplitudes.

In another aspect, the present disclosure provides a computer system. The computer system includes one or more processors and a memory. The memory is coupled to the one or more processors. The memory is used to store instructions. The instructions in the memory when executed by the one or more processors cause the one or more processors to perform a method. The one or more processors perform the method for standardizing media content for channel agnostic detection of television advertisements in real time. The method includes a step of normalization of each frame of a video corresponding to broadcasted media content on the channel. The method includes another step of derivation of one or more characteristics corresponding to one or more features. The one or more features are associated with media content for each channel of the plurality of channels. The method includes yet another step of trimming of a pre-defined percentage of area in each frame of the media content. The trimming of the pre-defined percentage of area is performed based on the one or more characteristics corresponding to the one or more features associated with the media content. The method includes yet another step of extraction of a first set of audio fingerprints and a first set of video fingerprints. The first set of audio fingerprints and the first set of video fingerprints correspond to a media content broadcasting on the channel. The method includes yet another step of detection of the one or more advertisements broadcasted across the plurality of channels in the real time. The normalization of each frame is done based on histogram normalization and histogram equalization. Moreover, the normalization of each frame is done by adjusting luminous intensity value of each pixel to a desired luminous intensity value. The one or more features associated with the channel include a logo associated with the channel and a ticker associated with the channel. The first set of audio fingerprints and the first set of video fingerprints are extracted sequentially in the real time. Moreover, the extraction of the first set of video fingerprints is done by sequentially extracting one or more prominent fingerprints. The one or more prominent fingerprints corresponds to the one or more prominent frames of a pre-defined number of frames present in the media content for a pre-defined interval of broadcast. The one or more advertisements are detected based on at least one of a supervised detection and an unsupervised detection.

In yet another aspect, the present disclosure provides a computer-readable storage medium. The computer readable storage medium enables encoding of computer executable instructions. The computer executable instructions when executed by at least one processor perform a method. The at least one processor performs the method for standardizing media content for channel agnostic detection of television advertisements in real time. The method includes a step of normalization of each frame of a video corresponding to broadcasted media content on the channel. The method includes another step of derivation of one or more characteristics corresponding to one or more features. The one or more features are associated with media content for each channel of the plurality of channels. The method includes yet another step of trimming of a pre-defined percentage of area in each frame of the media content. The trimming of the pre-defined percentage of area is performed based on the one or more characteristics corresponding to the one or more features associated with the media content. The method includes yet another step of extraction of a first set of audio fingerprints and a first set of video fingerprints. The first set of audio fingerprints and the first set of video fingerprints correspond to a media content broadcasting on the channel. The method includes yet another step of detection of the one or more advertisements broadcasted across the plurality of channels in the real time. The normalization of each frame is done based on histogram normalization and histogram equalization. Moreover, the normalization of each frame is done by adjusting luminous intensity value of each pixel to a desired luminous intensity value. The one or more features associated with the channel include a logo associated with the channel and a ticker associated with the channel. The first set of audio fingerprints and the first set of video fingerprints are extracted sequentially in the real time. Moreover, the extraction of the first set of video fingerprints is done by sequentially extracting one or more prominent fingerprints. The one or more prominent fingerprints corresponds to the one or more prominent frames of a pre-defined number of frames present in the media content for a pre-defined interval of broadcast. The one or more advertisements are detected based on at least one of a supervised detection and an unsupervised detection.

### BRIEF DESCRIPTION OF THE DRAWINGS

Having thus described the invention in general terms, reference will now be made to the accompanying drawings, which are not necessarily drawn to scale, and wherein:

FIG. 1A illustrates a system for standardizing media content for channel agnostic detection of television advertisements in real time, in accordance with various embodiments of the present disclosure;

FIG. 1B illustrates a system for an unsupervised detection of the one or more advertisements broadcasted across the channels, in accordance with an embodiment of the present disclosure;

FIG. 1C illustrates a system for a supervised detection of the one or more advertisements broadcasted across the channels, in accordance with another embodiment of the present disclosure;

FIG. 2 illustrates a block diagram of an advertisement detection system, in accordance with various embodiments of the present disclosure;

FIG. 3 illustrates a flow chart for channel feature agnostic detection of the one or more advertisements across channels, in accordance with various embodiments of the present disclosure; and FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

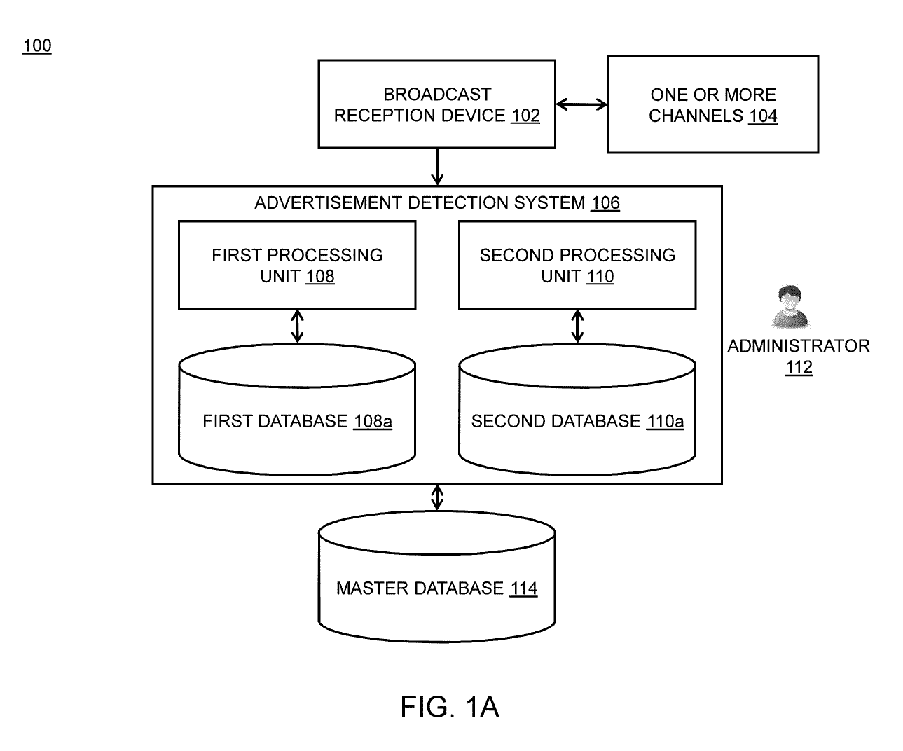

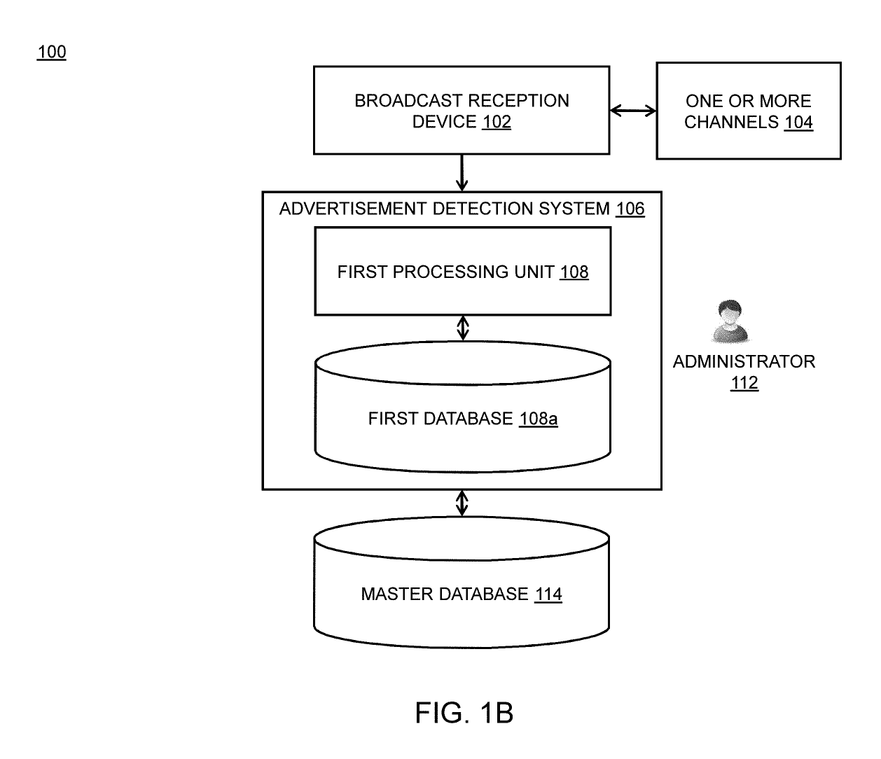

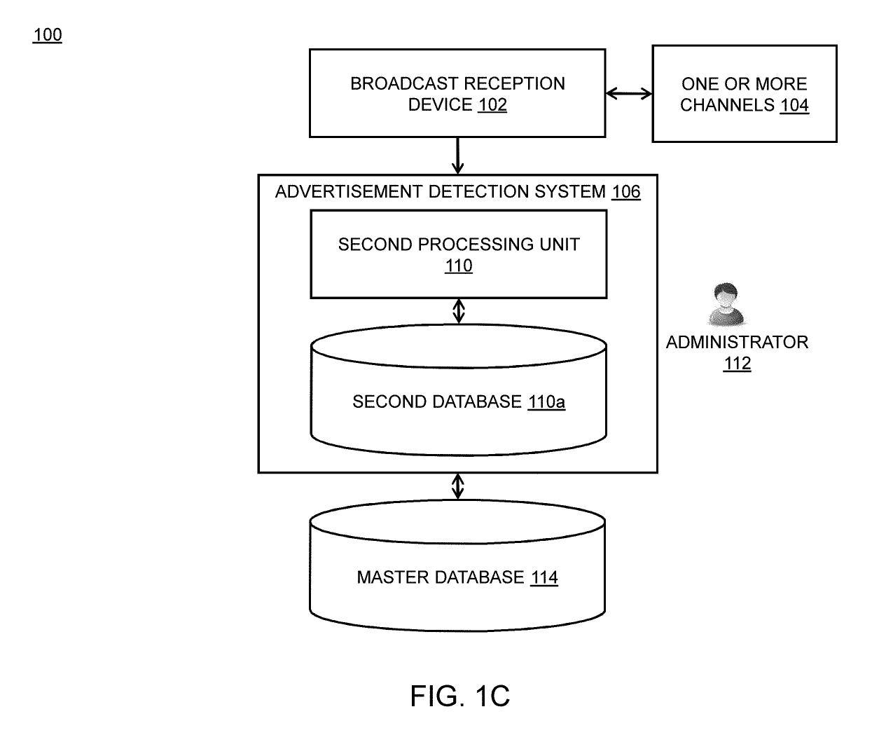

FIG. 1A illustrates a system 100 for standardizing media content for channel agnostic detection of television advertisements across a plurality of channels, in accordance with various embodiments of the present disclosure. The system 100 performs a supervised and an unsupervised detection of the one or more advertisements broadcasted across the channels in real time. In addition, the system 100 performs the detection of the one or more advertisements across the channels based on one or more characteristics of one or more features associated with the channel (described below in the patent application). Moreover, the system 100 is configured to provide a setup for the detection of the one or more advertisements.

The system 100 includes a broadcast reception device 102, an advertisement detection system 106 and a master database 114. The above stated elements of the system 100 operate coherently and synchronously to detect the one or more advertisements present in media content broadcasted in the channel. The above stated elements of the system 100 operate coherently and synchronously to detect the one or more advertisements based on the one or more properties of the channel. The broadcast reception device 102 is a channel feed receiving and processing device. In an embodiment of the present disclosure, the broadcast reception device 102 receives media content corresponding to the broadcasted content having audio in the pre-defined regional language or the standard language. The media content corresponds to another channel. The broadcast reception device 102 is attached directly or indirectly to a receiving antenna or dish. The receiving antenna receives a broadcasted signal carrying one or more channel feeds. In an embodiment of the present disclosure, the broadcast reception device 102 receives media content corresponding to the broadcasted content having audio in the pre-defined regional language or the standard language. The media content corresponds to the channel of the one or more channels 104. In an embodiment of the present disclosure, the receiving antenna receives the broadcast signal carrying a live feed associated with each of one or more channels. The one or more channel feeds are encoded in a pre-defined format. In addition, the one or more channel feeds have a set of characteristics. The set of characteristics includes a frame rate, an audio sample rate, one or more frequencies and the like.

The broadcasted signal carrying the one or more channel feeds is initially transmitted from a transmission device. In an embodiment of the present disclosure, the broadcasted signal carrying the one or more channel feeds is a multiplexed MPEG-2 encoded signal having a constant bit rate. In another embodiment of the present disclosure, the broadcasted signal carrying the one or more channel feeds is a multiplexed MPEG-2 encoded signal having a variable bit rate. In yet another embodiment of the present disclosure, the broadcasted signal carrying the one or more channel feeds is any digital standard encoded signal. The bit rate is based on complexity of each frame in each of the one or more channel feeds. The quality of the multiplexed MPEG-2 encoded signal will be reduced when the broadcasted signal is too complex to be coded at a constant bit-rate. The bit rate of the variable bit-rate MPEG-2 streams is adjusted dynamically as less bandwidth is needed to encode the images with a given picture quality. In addition, the broadcasted signal is encrypted for a conditional access to a particular subscriber. The encrypted broadcast signal is uniquely decoded by the broadcast reception device 102 uniquely.

In an example, a digital TV signal is received on the broadcast reception device 102 as a stream of MPEG-2 data. The MPEG-2 data has a transport stream. The transport stream has a data rate of 40 megabits/second for a cable or satellite network. Each transport stream consists of a set of sub-streams. The set of sub-streams is defined as elementary streams. Each elementary stream includes an MPEG-2 encoded audio, an MPEG-2 encoded video and data encapsulated in an MPEG-2 stream. In addition, each elementary stream includes a packet identifier (hereinafter “PID”) that acts as a unique identifier for corresponding elementary stream within the transport stream. The elementary streams are split into packets in order to obtain a packetized elementary stream (hereinafter “PES”).

In an embodiment of the present disclosure, the broadcast reception device 102 is a digital set top box. In another embodiment of the present disclosure, the broadcast reception device 102 is a hybrid set top box. In yet another embodiment of the present disclosure, the broadcast reception device 102 is an internet protocol television (hereinafter IPTV) set top box. In yet another embodiment of the present disclosure, the broadcast reception device 102 is any standard broadcast signal processing device. Moreover, the broadcast reception device 102 may receive the broadcast signal from any broadcast signal medium.

In an embodiment of the present disclosure, the broadcast signal medium is an ethernet cable. In another embodiment of the present disclosure, the broadcast signal medium is a satellite dish. In yet another embodiment of the present disclosure, the broadcast signal medium is a coaxial cable. In yet another embodiment of the present disclosure, the broadcast signal medium is a telephone line having DSL connection. In yet another embodiment of the present disclosure, the broadcast signal medium is a broadband over power line (hereinafter “BPL”). In yet another embodiment of the present disclosure, the broadcast signal medium is an ordinary VHF or UHF antenna.

The broadcast reception device 102 primarily includes a signal input port, an audio output port, a video output port, a de-multiplexer, a video decoder, an audio decoder and a graphics engine. The broadcast signal carrying the one or more channel feeds is received at the signal input port. The broadcast signal carrying the one or more channel feeds is de-multiplexed by the de-multiplexer. The video decoder decodes the encoded video and the audio decoder decodes the encoded audio. The video and audio corresponds to a channel selected in the broadcast reception device 102. In general, the broadcast reception device 102 carries the one or more channel feeds multiplexed to form a single transporting stream. The broadcast reception device 102 can decode only one channel in real time.

Further, the decoded audio and the decoded video are received at the audio output port and the video output port. Further, the decoded video has a first set of features. The first set of features includes a frame height, a frame width, a frame rate, a video resolution, an aspect ratio, a bit rate and the like. Moreover, the decoded audio has a second set of features. The second set of features includes a sample rate, a bit rate, a bin size, one or more data points, one or more prominent frequencies and one or more prominent amplitudes. Further, the decoded video may be of any standard quality. In an embodiment of the present disclosure, the decoded video signal is a 144 p signal. In another embodiment of the present disclosure, the decoded video signal is a 240 p signal. In yet another embodiment of the present disclosure, the decoded video signal is a 360 p signal. In yet another embodiment of the present disclosure, the decoded video signal is a 480 p signal. In yet another embodiment of the present disclosure, the decoded video signal is a 720 p video signal. In yet another embodiment of the present disclosure, the decoded video signal is a 1080 p video signal. In yet another embodiment of the present disclosure, the decoded video signal is a 1080 i video signal. In yet another embodiment of the present disclosure, the decoded video signal is a 1440 p video signal. In yet another embodiment of the present disclosure, the decoded video signal is a 2160 p video signal. Here, p and i denotes progressive scan and interlace scan techniques.

Further, the decoded video and the decoded audio (hereinafter “media content”) are transferred to the advertisement detection system 106 through a transfer medium. The transfer medium can be a wireless medium or a wired medium. Moreover, the media content includes one or more television programs, the one or more advertisements, one or more channel related data, subscription related data, operator messages and the like. In an embodiment of the present disclosure, the media content broadcasted on the channel of the one or more channels 104 uses a pre-defined regional language in the audio. In another embodiment of the present disclosure, the media content broadcasted on the channel of the one or more channels 104 uses a standard language accepted nationally. The media content has a pre-defined frame rate, a pre-defined number of frames and a pre-defined bit rate for a pre-defined interval of broadcast.

Further, the broadcast reception device 102 broadcasts one or more channels 104 on a user end device. The user end device is connected to the broadcast reception device 102. In addition, the connection is done through one or more cables. The one or more cables connect corresponding one or more ports on the user end device with corresponding one or more ports on the broadcast reception device 102. The end user device is any device capable of allowing one or more users to access the one or more channels for watching media content in real time. In an embodiment of the present disclosure, the end user device includes a CRT television, a LED television, a LCD television, a plasma television and the like. In another embodiment of the present disclosure, the end user device is an internet connected television.

Furthermore, each of the one or more channels may be any type of channel of various types of channels. The various types of channels include sports channels, movie channels, news channels, regional channels, music channels and various other types of channels. The broadcast reception device 102 is associated with a media content broadcast enabler. The media content broadcast enabler provides the broadcast reception device 102 to the one or more users. In an embodiment of the present disclosure, the media content broadcast enabler provides the broadcast reception device 102 for allowing the one or more users to access and view the media content on the corresponding user end device. In an embodiment of the present disclosure, the media content broadcast enabler is associated with a company or an organization employed in construction and distribution of a plurality of broadcast reception devices.

In an embodiment of the present disclosure, the media content broadcast enabler acts as a third party interface for distributing the broadcast reception device 102 to the corresponding one or more users. Moreover, the media content broadcast enabler include but may not be limited to DTH (Direct to Home) provider, STB (set top box) provider, cable TV provider and the like. In an embodiment of the present disclosure, the media content broadcast enabler is located in a vicinity of the one or more users. In an embodiment of the present disclosure, the media content broadcast enabler is enabled to provide one or more media broadcasting services to the one or more users. In an embodiment of the present disclosure, the media content broadcast enabler is allotted a pre-defined range or area for providing the one or more media broadcasting services to the one or more users located or living in the pre-defined range or area.

Moreover, the media content broadcast enabler provides the one or more media content broadcasting services based on a subscription plan bought by the one or more users. The subscription plan corresponds to a plan from a pre-defined set of plans set by the media content broadcasting enabler and chosen by the one or more users. In an embodiment of the present disclosure, the subscription plan includes a pre-defined list of channels and a pre-determined amount of money for availing the subscription plan.

In an embodiment of the present disclosure, the one or more users pay the pre-determined amount of money at a regular basis to the media content broadcasting enabler for availing the subscription plan. In an embodiment of the present disclosure, the one or more users avail the one or more media broadcasting services of a same media service provider (the media content broadcasting enabler). In an embodiment of the present disclosure, the media content broadcasting enabler stores information of the one or more users in a server. In an embodiment of the present disclosure, the media content broadcast enabler maintains the server. Further, each of the one or more channels 104 is associated with one or more features. The one or more features associated with the media content of the channel of the one or more channels 104. The one or more features include a logo associated with the channel and a ticker associated with the channel. Each channel of the one or more channels 104 has a unique logo. In general, the logo of a channel represents an identity of the channel. In addition, the logo represents a unique name of the channel.

The unique name is written in a graphical format. In an embodiment of the present disclosure, the logo is a unique identification for the channel. In an embodiment of the present disclosure, the logo of each of the one or more channels 104 appears on each video frame of the media content broadcasted on the one or more channels 104. In another embodiment of the present disclosure, the logo appears on some video frames during the broadcasting of the media content on the one or more channels 104.

Furthermore, the ticker is a primarily horizontal text-based feature displayed on the screen of the channel of the one or more channels 104. In an embodiment of the present disclosure, the ticker is displayed in the graphical format residing in a unique region of the screen of the channel of the one or more channels 104. In another embodiment of the present disclosure, the ticker is displayed as a network of a long and thin scoreboard-style display presenting headlines, minor pieces of public information and the like.

In an embodiment of the present disclosure, the tickers are displayed as a plurality of scrolling text running from right to left across the screen of the channel. In another embodiment of the present disclosure, the tickers are displayed as the plurality of scrolling text running from left to right across the screen of the channel. In another embodiment of the present disclosure, the tickers are displayed in a static manner utilizing a flipping effect. The flipping effect allows each individual headline of one or more headlines to be displayed on the screen of the channel for pre-defined time duration before transitioning to the next headline. In an example of news channel X, a headline Y is displayed on the screen for 5 seconds before a headline Z tends to be displayed on the screen of the news channel X.

Going further, the advertisement detection system 106 includes a first processing unit 108 and a second processing unit 110. The advertisement detection system 106 has a built in media splitter configured to copy and transmit the media content synchronously to the first processing unit 108 and the second processing unit 110 in the real time. The first processing unit 108 includes a first central processing unit and associated peripherals for unsupervised detection of the one or more advertisements (also shown in FIG. 1B). The first processing unit 108 is connected to a first database 108a.

The first processing unit 108 is programmed to perform normalization of each frame of a video corresponding to the media content broadcasted across the channels. The first processing unit 108 normalizes each frame of the video based on histogram normalization. In addition, the first processing unit 108 normalizes each frame of the video based on histogram equalization. Moreover, the first processing unit 108 normalizes each frame by adjusting luminous intensity value of each pixel to a desired luminous intensity value. For example, if an original luminous intensity range of any frame E of the video is 30-200 and the desired luminous intensity range is 0-255, the first processing unit 108 automatically adjust the original luminous intensity range by subtracting 30 from the luminous intensity value associated with the original luminous intensity range of each pixel. An intermediate luminous intensity range obtained by the histogram normalization is 0-170. In addition, the first processing unit 108 multiplies the luminous intensity value of each pixel associated with the intermediate luminous intensity range by 255/170 to obtain the desired luminous intensity range of 0-255.

Further, the first processing unit 108 derives the one or more characteristics. The one or more characteristics correspond to the one or more features associated with the channel of the one or more channels 104. Moreover, the one or more characteristics include a first set of characteristics and a second set of characteristics. The first set of characteristics is associated with the logo of the channel. In addition, the second set of characteristics is associated with the ticker displayed on the channel. Moreover, the first set of characteristics includes a pre-defined height of the logo, a pre-defined width of the logo, a pre-defined position of the logo and the like. In addition, the second set of characteristics includes a pre-defined height of the ticker, a pre-defined width of the ticker, a pre-defined position of the ticker and the like.

Further, the first processing unit 108 is programmed to trim a pre-defined percentage of area in each frame of the media content broadcasted on the channel of the one or more channels. In an embodiment of the present disclosure, the pre-defined percentage of area is 30% of a frame area. In another embodiment of the present disclosure, the pre-defined percentage of area is any suitable area in each frame of the media content. The pre-defined percentage of area in each frame is trimmed based on the one or more characteristics of the one or more features associated with the media content. In an embodiment of the present disclosure, the pre-defined percentage of area is trimmed based on the pre-defined height of the logo and the pre-defined width of the logo derived by the first processing unit 108. In another embodiment of the present disclosure, the pre-defined percentage of area is trimmed based on the pre-defined height of the ticker and the pre-defined width of the ticker derived by the first processing unit 108. In yet another embodiment of the present disclosure, the pre-defined percentage of area is trimmed based on a combination of the pre-defined height of the logo and the pre-defined height of the ticker. In yet another embodiment of the present disclosure, the pre-defined percentage of area is trimmed based on the combination of the pre-defined width of the logo and the pre-defined width of the ticker. In yet another embodiment of the present disclosure, the pre-defined percentage of area is trimmed based on the combination of the pre-defined height of the logo and the pre-defined width of the ticker. In yet another embodiment of the present disclosure, the pre-defined percentage of area is trimmed based on the combination of the pre-defined width of the logo and the pre-defined height of the ticker.

Furthermore, the pre-defined percentage of area includes a first pre-defined region and a second pre-defined region. In an embodiment of the present disclosure, the first pre-defined region is associated with the logo of the channel. In another embodiment of the present disclosure, the first pre-defined region is associated with the ticker of the channel. In an embodiment of the present disclosure, the second pre-defined region is associated with the logo of the channel. In another embodiment of the present disclosure, the second pre-defined region is associated with the ticker of the channel. In an embodiment of the present disclosure, the first processing unit 108 trims the first pre-defined region associated with the logo of the channel. In another embodiment of the present disclosure, the first processing unit 108 trims the second pre-defined region associated with the ticker of the channel. In yet another embodiment of the present disclosure, the first processing unit 108 trims the first pre-defined region associated with the logo and the second pre-defined region associated with the ticker both.

The first processing unit 108 trims the pre-defined percentage of area to a pre-defined scale. In an embodiment of the present disclosure, the pre-defined scale is 640 by 480. In another embodiment of the present disclosure, the pre-defined scale is 1024 by 768. In yet another embodiment of the present disclosure, the pre-defined scale is 1124 by 768. In yet another embodiment of the present disclosure, the pre-defined scale is 1920 by 1080. In yet another embodiment of the present disclosure, the pre-defined scale is 1366 by 768. In yet another embodiment of the present disclosure, the pre-defined scale is any suitable scale.

Going further, the first processing unit 106 is programmed to perform extraction of a first set of audio fingerprints and a first set of video fingerprints corresponding to the media content broadcasted on the channel. The first set of audio fingerprints and the first set of video fingerprints are associated with a specific cropped area. The specific cropped area is obtained after normalizing, scaling and trimming of each frame. The first processing unit 108 trims the pre-defined percentage of area to obtain the specific cropped area. The first set of video fingerprints and the first set of audio fingerprints are extracted sequentially from the specific cropped area in the real time. The extraction of the first set of video fingerprints is done by sequentially extracting one or more prominent fingerprints corresponding to one or more prominent frames associated with the media content. Each of the one or more prominent frames has the specific cropped area. Moreover, the one or more prominent frames correspond to the pre-defined interval of broadcast.

For example, let the media content be related to a channel say, A. The channel A broadcasts a 1 hour news show between 9 PM to 10 PM. Suppose the media content is broadcasted on the channel A with a frame rate of 25 frames per second (hereinafter “fps”). Again let us assume that the channel A administrator has placed 10 advertisements in between 1 hour broadcast of the news show. The first processing unit 108 separates audio and video from the media content corresponding to the news show in the real time. Further, the first processing unit 108 sets a pre-defined range of time to approximate duration of play of every advertisement. Let us suppose the pre-defined range of time is between 15 seconds to 35 seconds. The first processing unit 108 processes each frame of the pre-defined number of frames of the 1 hour long news show. The first processing unit 108 filters and selects prominent frames having dissimilar scenes. The first processing unit 108 extracts relevant characteristics corresponding to each prominent frame. The relevant characteristics constitute a digital video fingerprint. Similarly, the first processing unit 108 extracts the first set of audio fingerprints corresponding to the media content.

Furthermore, each of the one or more prominent fingerprints corresponds to a prominent frame having sufficient contrasting properties compared to an adjacent prominent frame. For example, let us suppose that the first processing unit 108 select 5 prominent frames per second from 25 frames per second. Each pair of adjacent frames of the 5 prominent frames will have evident contrasting properties. The first processing unit 108 generates a set of digital signature values corresponding to an extracted set of video fingerprints. The first processing unit 108 generates each digital signature value of the set of digital signature values by dividing each prominent frame of the one or more prominent frames into a pre-defined number of blocks. In an embodiment of the present disclosure, the predefined number of block is 16 (4×4). In another embodiment of the present disclosure, the pre-defined number of blocks is any suitable number. Each block of the pre-defined number of blocks has a pre-defined number of pixels. Each pixel is fundamentally a combination of red (hereinafter “R”), green (hereinafter “G”) and blue (hereinafter “B”) colors. The colors are collectively referred to as RGB. Each color of a pixel (RGB) has a pre-defined value in a pre-defined range of values. The predefined range of values is 0-255.

In an example, the RGB for the pixel has value of 000000. The color of pixel is black. In another example, the RGB for the pixel has a value of FFFFFF (255; 255; 255). The color of the pixel is white. Here, FF is hexadecimal equivalent of decimal, 255. In yet another example, the RGB for the pixel has a value of FF0000 (255, 0, 0).

The color of the pixel is red. In yet another example, the RGB for the pixel has a value of 0000FF (0, 0, 255). The color of the pixel is blue. In yet another example, the RGB for the pixel has a value of 008000 (0, 128, 0). The color of the pixel is green.

The first processing unit 108 gray-scales each block of each prominent frame of the one or more prominent frames. In general, the gray-scaling of each block is a conversion of RGB to monochromatic shades of gray color. Here 0 represents black and 255 represents white. Further, the first processing unit 108 calculates a first bit value and a second bit value for each block of the prominent frame. The first bit value and the second bit value are calculated from comparing a mean and a variance for the pre-defined number of pixels in each block of the prominent frame with a corresponding mean and variance for a master frame in the master database 114. The first processing unit 108 assigns the first bit value and the second bit with a binary 0 when the mean and the variance for each block of the prominent frame is less the corresponding mean and variance of each master frame. The first processing unit 108 assigns the first bit value and the second bit value with a binary 1 when the mean and the variance for each block is greater than the corresponding mean and variance of each master frame.

Furthermore, the first processing unit 108 obtains a 32 bit digital signature value corresponding to each prominent frame having the specific cropped area. The 32 bit digital signature value is obtained by sequentially arranging the first bit value and the second bit value for each block of the pre-defined number of blocks of the prominent frame. The first processing unit 108 stores each digital signature value corresponding to each prominent frame of the one or more prominent frames in the first database 108a. The digital signature value corresponds to the one or more programs and the one or more advertisements. The first processing unit 108 utilizes a temporal recurrence algorithm to detect the one or more advertisements. In temporal recurrence algorithm, the first processing unit 108 probabilistically matches a first pre-defined number of digital signature values with a stored set of digital signature values present in the first database 108a.

In an example, let us suppose that the first processing unit 106 generates 100 digital signature values corresponding to 100 prominent frames each having the specific cropped area in the first database 106a. The first processing unit 106 probabilistically matches 20 digital signature values corresponding to 101^{st} to 121^{st} prominent frame with each 20 digital signature values corresponding to 100 previously stored prominent frames.

The probabilistic match of the first pre-defined number of digital signature values sequentially for each of the prominent frame is performed by utilizing a sliding window algorithm. In an embodiment of the present disclosure, the first pre-defined number of digital signature values of the set of digital signature values for the unsupervised detection of the one or more advertisements is 20. The first processing unit 108 determines a positive probabilistic match of the pre-defined number of prominent frames based on a pre-defined condition. The pre-defined condition includes a pre-defined range of positive matches corresponding to probabilistically match digital signature values and a pre-defined duration of media content corresponding to the positive match. In addition, the pre-defined condition includes a sequence and an order of the positive matches and a degree of match of a pre-defined range of number of bits of the first pre-defined number of signature values. In an embodiment of the present disclosure, the pre-defined range of probabilistic matches corresponding to the positive match lies in a range of 40 matches to 300 matches. In another embodiment of the present disclosure, the pre-defined range of probabilistic matches corresponding to the positive match lies in a suitable duration of each advertisement running time. In an embodiment of the present disclosure, the first processing unit 108 discards the probabilistic matches corresponding to less than 40 positive matches.

Further, the pre-defined duration of media content corresponding to the positive match has a first limiting duration bounded by a second limiting duration. In an embodiment of the present disclosure, the first limiting duration is 10 seconds and the second limiting duration is 25 seconds. In another embodiment of the present disclosure, the first limiting duration is 10 seconds and the second limiting duration is 35 seconds. In yet another embodiment of the present disclosure, the first limiting duration is 10 seconds and the second limiting duration is 60 seconds. In yet another embodiment of the present disclosure, the first limiting duration is 10 seconds and the second limiting duration is 90 seconds. In yet another embodiment of the present disclosure, the first limiting duration and the second limiting duration may have any suitable limiting durations.

In an example, suppose 100 digital signature values from 1100^{th} prominent frame to 1200^{th} prominent frame gives a positive match with a stored 100^{th} frame to 200^{th} frame in the first database 106a. The first processing unit 106 checks whether the number of positive matches is in the pre-defined range of positive matches. In addition, the first processing unit 106 checks whether the positive matches correspond to media content is in the first limiting duration and the second limiting duration. Moreover, the first processing unit 108 checks whether the positive matches of 100 digital signature values for unsupervised detection of the one or more advertisements is in a required sequence and order.

The first processing unit 108 checks for the degree of match of the pre-defined range of number of bits of the first pre-defined number of signature values. In an example, the degree of match of 640 bits (32 Bits×20 digital signature values) of the generated set of digital signature values with stored 640 digital signature values is 620 bits. In such case, the first processing unit 108 flags the probabilistic match as the positive match. In another example, the degree of match of 640 bits of the generated set of digital signature values with stored 640 digital signature values is 599 bits. In such case, the first processing unit 108 flags the probabilistic match as the negative match. In an embodiment of the present disclosure, the pre-defined range of number of bits is 0-40.

Furthermore, the first processing unit 108 performs a range based matching of the digital signature values across the channels of the plurality of channels 108. In an example, a first channel S displays an ad in one or more slots. A second channel T displays the same ad in one or more slots. Here, the one or more slots for the first channel S may differ from the one or more ads in the second channel A. The first channel S display the ad with a corresponding channel logo overlaid and the second channel T displays the same ad with the corresponding channel logo and a dynamically changing ticker in a relatively smaller area of the frame positioned specifically. The first processing unit 108 trims the pre-defined percentage of area in each frame corresponding to the one or more ads broadcasted on the first channel S and the second channel T. In addition, the first processing unit 108 probabilistically matches each prominent frame having the specific cropped area for the ad broadcasted on the first channel S with the each prominent frame having the specific cropped area for ad broadcasted in the second channel T. Moreover, the first processing unit 108 treats the one or more ad broadcasted across the channel of the one or more channels 104 as a single ad based on positive matching results.

Further, the first processing unit 108 generates one or more prominent frequencies and one or more prominent amplitudes from extracted first set of audio fingerprints. The first processing unit 108 fetches a sample rate of first set of audio fingerprints. The sample rate is divided by a pre-defined bin size set for the audio. The division of the sample rate by the pre-defined bin size provides the data point. Further, the first processing unit 108 performs fast fourier transform (hereinafter “FFT”) on each bin size of the audio to obtain the one or more prominent frequencies and the one or more prominent amplitudes. The first processing unit 108 compares the one or more prominent frequencies and the one or more prominent amplitudes with a stored one or more prominent frequencies and a stored one or more prominent amplitudes.

Going further, the first processing unit 108 fetches the corresponding video and audio clip associated to the probabilistically matched digital signature values. The first database 108a and the first processing unit 108 are associated with an administrator 112. The administrator 112 is associated with a display device and a control and input interface. In addition, the display device is configured to display a graphical user interface (hereinafter “GUI”) of an installed operating system. The administrator 112 checks for the presence of the audio and the video clip manually in the master database 114. The administrator 112 decides whether the audio clip and the video clip correspond to a new advertisement. The administrator 112 tags each audio clip and the video clip with a tag. The tag corresponds to a brand name associated with a detected advertisement. Moreover, the administrator 112 stores the metadata of the probabilistically matched digital fingerprint values in the master database 114.

In an embodiment of the present disclosure, the first processing unit 108 extracts the first set of audio fingerprints and the first set of video fingerprints corresponding to another channel. The first processing unit 108 extracts the pre-defined number of prominent frames and generates pre-defined number of digital signature values. The first processing unit 108 performs the temporal recurrence algorithm to detect a new advertisement. In an embodiment of the present disclosure, the first processing unit 108 generates prominent frequencies and prominent amplitudes of the audio. In another embodiment of the present disclosure, the first processing unit 108 discards the audio from the media content. In an embodiment of the present disclosure, the first processing unit 108 probabilistically matches the one or more prominent frequencies and the one or more prominent amplitudes with stored prominent frequencies and stored prominent amplitudes in the first database. The stored prominent frequencies and the stored prominent amplitudes correspond to a regional channel having audio in the pre-defined regional language or standard language. In an embodiment of the present disclosure, the standard language is English. In another embodiment of the present disclosure, the first processing unit 108 gives precedence to results of probabilistic match of video fingerprints than to the audio fingerprints. In an embodiment of the present disclosure, the administrator 112 manually tags the detected advertisement broadcasted in the pre-defined regional language or the standard language. In another embodiment of the present disclosure, the advertisement detection system 106 automatically tags the detected advertisement broadcasted in the pre-defined regional language or the standard language.

In addition, the first processing unit 108 reports a positively matched digital signature values corresponding to each detected advertisement in a reporting database present in the first database 108a. The first processing unit 108 discards any detected advertisement already reported in the reporting database.

The second processing unit 110 includes a second central processing unit and associated peripherals for supervised detection of the one or more advertisements (also shown in FIG. 1C). The second processing unit 110 performs normalization, scaling and trimming of each frame of the media content for removal of channel logos and tickers. The second processing unit 110 is connected to a second database 110a. The second processing unit 110 is programmed to perform the extraction of the first set of audio fingerprints and the first set of video fingerprints corresponding to a normalized and scaled media content broadcasted on the channel. The first set of video fingerprints and the first set of audio fingerprints are extracted sequentially in the real time. The extraction of the first set of video fingerprints is done by sequentially extracting the one or more prominent fingerprints corresponding to the one or more prominent frames for the pre-defined interval of broadcast.

Furthermore, each of the one or more prominent fingerprints corresponds to the prominent frame having sufficient contrasting features compared to the adjacent prominent frame. For example, let us suppose that the second processing unit 110 selects 6 prominent frames per second from 25 frames per second. Each pair of adjacent frames of the 6 prominent frames will have evident contrasting features. The second processing unit 110 generates the set of digital signature values corresponding to the extracted set of video fingerprints. The second processing unit 110 generates each digital signature value of the set of digital signature values by dividing each prominent frame of the one or more prominent frames into the pre-defined number of blocks. In an embodiment of the present disclosure, the predefined number of block is 15 (4×4). In another embodiment of the present disclosure, the pre-defined number of blocks is any suitable number. Each block of the pre-defined number of blocks has the pre-defined number of pixels. Each pixel is fundamentally the combination of R, G and B colors. The colors are collectively referred to as RGB. Each color of the pixel (RGB) has the pre-defined value in the pre-defined range of values. The predefined range of values is 0-255.

The second processing unit 110 gray-scales each block of each prominent frame of the one or more prominent frames. The second processing unit 110 calculates the first bit value and the second bit value for each block of the prominent frame. The first bit value and the second bit value are calculated from comparison of the mean and the variance for the pre-defined number of pixels with the corresponding mean and variance for the master frame. The master frame is present in the master database 114. The second processing unit 110 assigns the first bit value and the second bit with the binary 0 when the mean and the variance for each block is less the corresponding mean and variance of each master frame. The second processing unit 110 assigns the first bit value and the second bit value with the binary 1 when the mean and the variance for each block is greater than the corresponding mean and variance of each master frame.

The second processing unit 110 obtains the 32 bit digital signature value corresponding to each prominent frame. The 32 bit digital signature value is obtained by sequentially arranging the first bit value and the second bit value for each block of the pre-defined number of blocks of the prominent frame. The second processing unit 110 stores each digital signature value corresponding to each prominent frame of the one or more prominent frames in the second database 110a. The digital signature value corresponds to the one or more programs and the one or more advertisements. The second processing unit 110 performs the supervised detection of the one or more advertisements. The second processing unit 110 probabilistically matches a second pre-defined number of digital signature values with the stored set of digital signature values present in the master database 114. The second pre-defined number of digital signature values corresponds to the second pre-defined number of prominent frames of the real time broadcasted media content. The probabilistic match is performed for the set of digital signature values by utilizing a sliding window algorithm. The second processing unit 110 determines the positive match in the probabilistically matching of the second pre-defined number of digital signature values with the stored set of digital signature values. The stored set of digital signature values is present in the master database 114. In an embodiment of the present disclosure, the second pre-defined number of digital signature values of the set of digital signature values for the supervised detection of the one or more advertisements is 6. In another embodiment of the present disclosure, the second pre-defined number of digital signature values is selected based on optimal processing capacity and performance of the second processing unit 110.

In an example, let us suppose that the second processing unit 108 stores 300 digital signature values corresponding to 300 prominent frames in the second database 108a for 10 seconds of the media content. The second processing unit 108 probabilistically matches 6 digital signature values corresponding to 101^{st} to 107^{nth} prominent frame with each 6 digital signature values corresponding to 300 previously stored prominent frames. The 300 previously stored prominent frames are present in the master database 112.

In another example, suppose 300 digital signature values from 600^{th} prominent frame to 900^{th} prominent frame gives a positive match with a stored 150^{th} frame to 450th frame in the master database 114. The second processing unit 110 checks whether the number of positive matches is in the pre-defined range of positive matches and the positive matches correspond to media content in the first limiting duration and the second limiting duration. In addition, the second processing unit 110 checks whether the positive matches of 300 digital signature values for supervised detection of the one or more advertisements is in the required sequence and order.

The second processing unit 110 checks for the degree of match of the pre-defined range of number of bits of the second pre-defined number of signature values. In an example, the degree of match of 192 bits of the generated set of digital signature values with stored 192 digital signature values is 185 bits. In such case, the second processing unit 110 flags the probabilistic match as the positive match. In another example, the degree of match of 192 bits of the generated set of digital signature values with stored 192 digital signature values is 179 bits. In such case, the second processing unit 110 flags the probabilistic match as the negative match. In an embodiment of the present disclosure, the pre-defined range of number of bits is 0-12.

The second processing unit 110 compares the one or more prominent frequencies and the one or more prominent amplitudes with the stored one or more prominent frequencies and the stored one or more prominent amplitudes. The one or more prominent frequencies and the one or more prominent amplitudes corresponding to the extracted first set of audio fingerprints. In an embodiment of the present disclosure, the administrator 112 manually checks whether each supervised advertisement detected is an advertisement or a program.

In an embodiment of the present disclosure, the advertisement detection system 106 reports a frequency of each advertisement broadcasted for a first time and a frequency of each advertisement broadcasted repetitively. In another embodiment of the present disclosure, the administrator 112 reports the frequency of each advertisement broadcasted for the first time and the frequency of each advertisement broadcasted repetitively.

In an embodiment of the present disclosure, the second processing unit 110 extracts the first set of audio fingerprints and the first set of video fingerprints corresponding to another channel. The second processing unit 110 extracts the pre-defined number of prominent frames and generates pre-defined number of digital signature values. The second processing unit 110 performs probabilistic matching of digital signature values corresponding to the video with the stored digital signature values in the master database 114 detect a repeated advertisement. In an embodiment of the present disclosure, the second processing unit 110 generates the one or more prominent frequencies and the one or more prominent amplitudes of the audio. In another embodiment of the present disclosure, the second processing unit 110 discards the audio from the media content. In an embodiment of the present disclosure, the master database 114 includes the one or more advertisements corresponding to a same advertisement in every regional language. In another embodiment of the present disclosure, the master database 114 includes the advertisement in a specific national language. In embodiment of the present disclosure, the second processing unit 110 probabilistically matches the one or more prominent frequencies and the one or more prominent amplitudes with stored prominent frequencies and stored prominent amplitudes. The stored prominent frequencies and the stored prominent amplitudes correspond to a regional channel having audio in the pre-defined regional language or standard language in the master database 114. In an embodiment of the present disclosure, the standard language is English. In another embodiment of the present disclosure, the second processing unit 110 gives precedence to results of probabilistic match of video fingerprints than to the audio fingerprints.

Further, the master database 114 is present in a master server. The master database 114 includes a plurality of digital video and audio fingerprint records and every signature value corresponding to each previously detected and newly detected advertisement. The master database 114 is connected to the advertisement detection system 106. In an embodiment of the present disclosure, the master server is present in a remote location. In another embodiment of the present disclosure, the master server is present locally with the advertisement detection system 106.

Further, the advertisement detection system 106 stores the generated set of digital signature values, the first set of audio fingerprints and the first set of video fingerprints in the first database 108a and the second database 110a. Furthermore, the advertisement detection system 106 updates the first metadata manually in the master database 114 for the unsupervised detection of the one or more advertisements. The first metadata includes the set of digital signature values and the first set of video fingerprints.

It may be noted that in FIG. 1A, FIG. 1B and FIG. 1C, the system 100 includes the broadcast reception device 102 for decoding one channel; however, those skilled in the art would appreciate the system 100 includes more number of broadcast reception devices for decoding more number of channels. It may be noted that in FIG. 1A, FIG. 1B and FIG. 1C, the system 100 includes the advertisement detection system 106 for the supervised and the unsupervised detection of the one or more advertisement corresponding to one channel; however, those skilled in the art would appreciate that the advertisement detection system 106 detects the one or more advertisements corresponding to more number of channels. It may be noted that in FIG. 1A, FIG. 1B and FIG. 1C, the administrator 112 manually checks each newly detected advertisement in the master database 114; however, those skilled in the art would appreciate that the advertisement detection system 106 automatically checks for each advertisement in the master database 114.

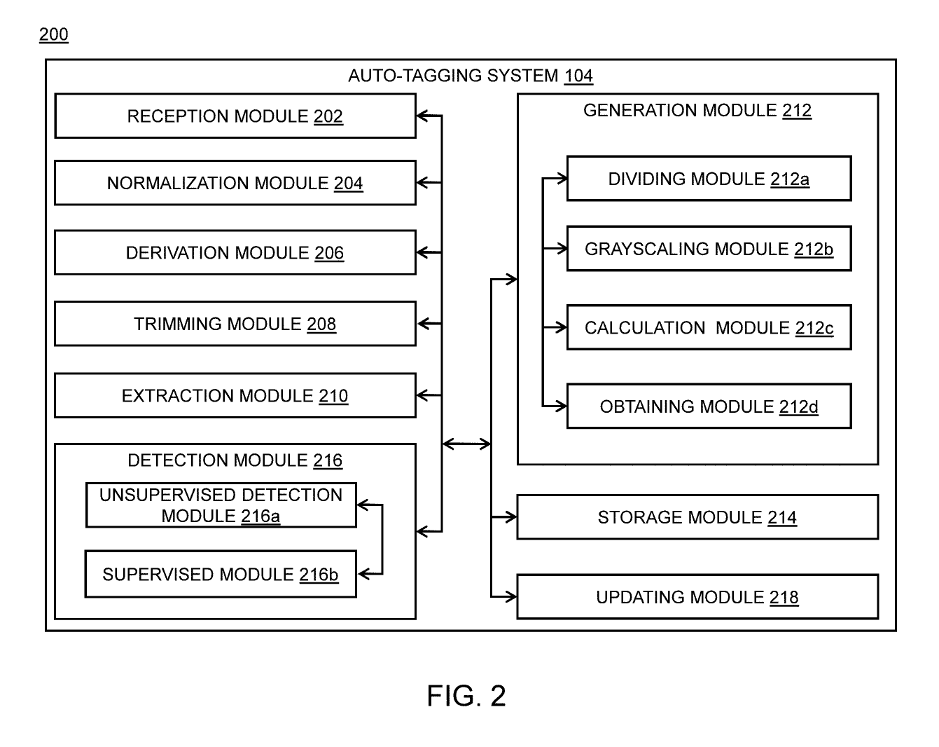

FIG. 2 illustrates a block diagram 200 of the advertisement detection system 106, in accordance with various embodiments of the present disclosure. It may be noted that to explain the system elements of the FIG. 2, references will be made to the system elements of the FIG. 1A, FIG. 1B and FIG. 1C. The block diagram 200 describes the advertisement detection system 106 configured for the unsupervised and the supervised detection of the one or more advertisements.

The block diagram 200 of the advertisement detection system 106 includes a reception module 202, a normalization module 204, a derivation module 206, a trimming module 208, an extraction module 210 and a generation module 212. In addition, the block diagram 200 of the advertisement detection system 106 includes a storage module 214, a detection module 216 and an updating module 218. The reception module 202 receives the live feed associated with a media content broadcasted on the channel in the real time (as discussed above in the detailed description of FIG. 1A). The normalization module 204 normalizes each frame of the video corresponding to the media content broadcasted on the channel. The normalization module normalizes each frame based on the histogram normalization and the histogram equalization (as described above in the detailed description of FIG. 1A).

The derivation module 206 derives the one or more characteristics corresponding to the one or more features associated with the media content for each channel of the plurality of channels. The one or more characteristics includes the first set of characteristics associated with the logo of the channel and the second set of characteristics associated with the ticker displayed on the channel (as discussed above in the detailed description of FIG. 1A). The trimming module 208 trims the pre-defined percentage of area in each frame of the media content. The trimming module 208 trims based on the one or more characteristics corresponding to the one or more features associated with the media content (as stated above in the detailed description of FIG.

1A).

The extraction module 210 extracts the first set of audio fingerprints and the first set of video fingerprints corresponding to the media content broadcasted in the specific cropped area of the channel. The first set of audio fingerprints and the first set of video fingerprints are extracted sequentially in the real time (as shown in detailed description of FIG. 1A). Further, the generation module 212 generates the set of digital signature values corresponding to the extracted set of video fingerprints. The generation module 212 generates each digital signature value of the set of digital signature values by dividing and grayscaling each prominent frame into the pre-defined number of blocks. Further, the generation module 212 calculates and obtains each digital signature value corresponding to each block of the prominent frame (as shown in detailed description of FIG. 1A).

Furthermore, the generation module 212 includes a division module 212a, a grayscaling module 212b, a calculation module 212c and an obtaining module 212d. The division module 212a divides each prominent frame of the one or more prominent frames into the pre-defined number of blocks (as shown in detailed description of FIG. 1A). The grayscaling module 212b grayscales each block of each prominent frame of the one or more prominent frames. The calculation module 212c calculates the first bit value and the second bit value for each block of the prominent frame (as described in the detailed description of FIG. 1A). The obtaining module 212d obtains the 32 bit digital signature value corresponding to each prominent frame (as described in detailed description of FIG. 1A).

The storage module 214 stores the generated set of digital signature values, the first set of audio fingerprints and the first set of video fingerprints in the first database 108a and the second database 110a (as described above in detailed description of FIG. 1A). Further, the detection module 216 detects the one or more advertisements broadcasted on the channel. The detection module 216 includes an unsupervised detection module 216a and the supervised detection module 216b. The unsupervised detection module 216a detects the new advertisement through unsupervised machine learning (as discussed in the detailed description of FIG. 1A and FIG. 1B). The unsupervised detection module 216a probabilistically matches the first pre-defined number of digital signature values corresponding to the pre-defined number of prominent frames with the stored set of digital signature values (as described in detailed description of FIG. 1A).

Furthermore, the unsupervised detection module 216a compares the one or more prominent frequencies and the one or more prominent amplitudes of the extracted first set of audio fingerprints (as described in detailed description of FIG. 1A), In addition, the unsupervised detection module 216a determines the positive probabilistic match of the pre-defined number of prominent frames based on the pre-defined condition (as described in the detailed description of FIG. 1A). Moreover, the unsupervised detection module 216a fetches the video and the audio clip corresponding to the probabilistically matched digital signature values (as described in the detailed description of FIG. 1A). In addition, the unsupervised detection module 216a checks presence of the audio and the video clip manually in the master database 112 (as described in detailed description of FIG. 1A), Furthermore, the unsupervised detection module 216a reports the positively matched digital signature values corresponding to the advertisement of the one or more advertisements in the reporting database present in the first database 108a (as described in the detailed description of FIG. 1A).

The supervised detection module 216b detects the advertisements broadcasted previously during the broadcasting of the media content (as described above in the detailed description of FIG. 1A and FIG. 1C), The supervised detection module 216b probabilistically matches the second pre-defined number of digital signature values with the stored set of digital signature values present in the master database 114 (as described above in the detailed description of FIG. 1A). Further, the supervised detection module 216b compares the one or more prominent frequencies and the one or more prominent amplitudes with the stored one or more prominent frequencies and the stored one or more prominent amplitudes (as described in the detailed description of FIG. 1A). The supervised detection module 216b determines the positive match in the probabilistically matching of the second pre-defined number of digital signature values with the stored set of digital signature values in the master database 114. In addition, the supervised detection module 216b determines the positive match from the comparison of the one or more prominent frequencies with the stored one or more prominent frequencies (as described in the detailed description of FIG. 1A),

Going further, the updating module 218 updates the first metadata manually in the master database 114 for the unsupervised detection of the one or more advertisements. The first metadata includes the set of digital signature values and the first set of video fingerprints corresponding to the detected advertisement (as described in the detailed description of FIG. 1A).

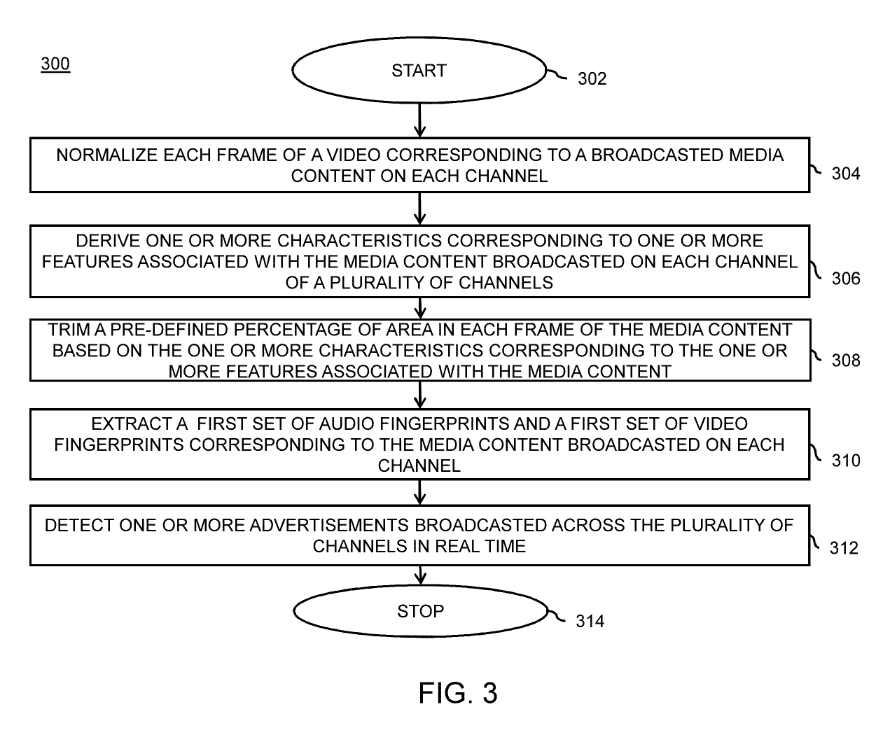

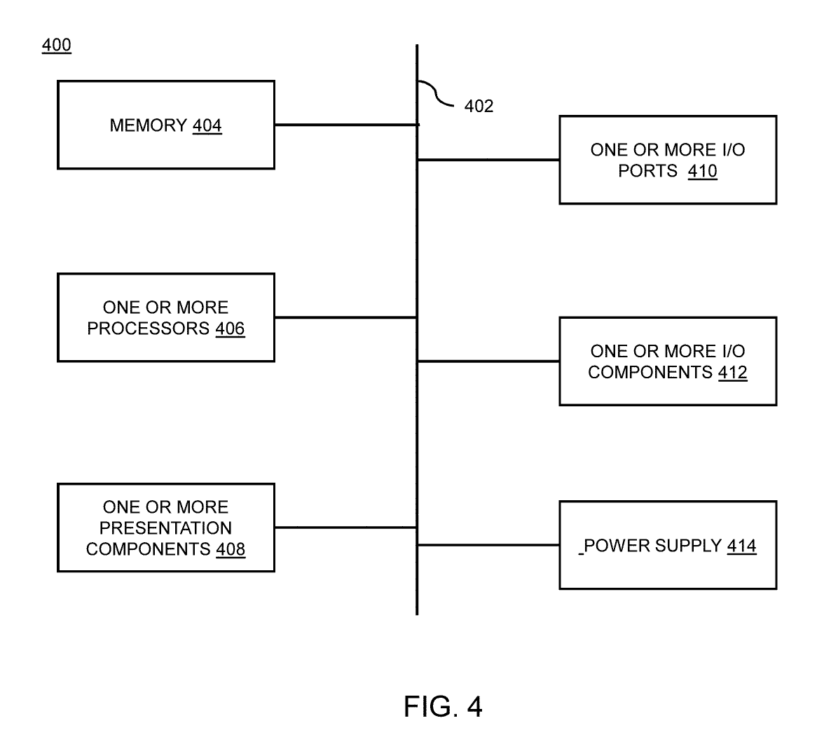

FIG. 3 illustrates a flow chart 300 for channel feature agnostic detection of the one or more advertisements across channels, in accordance with various embodiments of the present disclosure. It may be noted that to explain the process steps of the flowchart 300, references will be made to the system elements of the FIG. 1A, FIG. 1B, FIG. 1C and FIG. 2.

The flowchart 300 initiates at step 302. At step 304, the normalization module 204 normalizes each frame of the video corresponding to the broadcasted media content on each channel. At step 306, the derivation module 206 derives the one or more characteristics corresponding to the one or more features associated with the media content for each channel of the plurality of channels. Further, at step 308, the trimming module 208 trims the pre-defined percentage of area in each frame of the media content. The pre-defined percentage of area is trimmed based on the one or more characteristics corresponding to the one or more features associated with the media content. At step 310, the extraction module 210 extracts the first set of audio fingerprints and the first set of video fingerprints corresponding to the media content broadcasted on each channel. Further, at step 312, the detection module 216 detects the one or more advertisements broadcasted across the plurality of channels in the real time. The flow chart 300 terminates at step 314.

It may be noted that the flowchart 300 is explained to have above stated process steps; however, those skilled in the art would appreciate that the flowchart 300 may have more/less number of process steps which may enable all the above stated embodiments of the present disclosure.

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more buses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The present disclosure has numerous disadvantages over the prior art. The present disclosure provides a novel method to detect any new advertisement running for the first time on any television channel. The advertisements are detected robustly and dedicated supervised and unsupervised central processing unit (hereinafter “CPU”) are installed. Further, the present disclosure provides a method and system that is economic and provides high return of investment. The detection of each repeated advertisement on supervised CPU and each new advertisement on unsupervised CPU significantly saves processing power and saves significant time. The disclosure provides a cost efficient solution to a scaled mapping and database for advertisement broadcast.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for standardizing media content for channel agnostic detection of television advertisements, the computer-implemented method comprising:
normalizing, at an advertisement detection system with a processor, each frame of a video corresponding to the broadcasted media content on each channel, wherein the normalization of each frame being done based on a histogram normalization and a histogram equalization and wherein the normalization of each frame being done by adjusting luminous intensity value of each pixel to a desired luminous intensity value;
deriving, at the advertisement detection system with the processor, one or more characteristics corresponding to one or more features associated with the media content broadcasted on each channel of a plurality of channels, wherein the one or more features associated with each channel comprises a logo associated with each channel and a ticker associated with each channel;
trimming, at the advertisement detection system with the processor, a pre-defined percentage of area in each frame of the media content based on the one or more characteristics corresponding to the one or more features associated with the media content;
extracting, at the advertisement detection system with the processor, a first set of audio fingerprints and a first set of video fingerprints corresponding to the media content broadcasted on each channel, wherein the first set of audio fingerprints and the first set of video fingerprints being extracted sequentially in real time, wherein the extraction of the first set of video fingerprints being done by sequentially extracting one or more prominent fingerprints corresponding to one or more prominent frames of a pre-defined number of frames present in the media content for a pre-defined interval of broadcast; and
detecting, at the advertisement detection system with the processor, one or more advertisements broadcasted across the plurality of channels in real time, wherein the one or more advertisements being detected based on at least one of a supervised detection and an unsupervised detection.

2. The computer-implemented method as recited in claim 1, wherein the one or more characteristics comprises a first set of characteristics associated with the logo of each channel and a second set of characteristics associated with the ticker associated with each channel, wherein the first set of characteristics comprises a pre-defined height of the logo, a pre-defined width of the logo and a pre-defined position of the logo and wherein the second set of characteristics comprises a pre-defined height of the ticker, a pre-defined width of the ticker and a pre-defined position of the ticker.

3. The computer-implemented method as recited in claim 1, wherein the pre-defined percentage of area in each frame being trimmed to a pre-defined scale and wherein the pre-defined scale of each frame being 640×480.

4. The computer-implemented method as recited in claim 1, wherein the pre-defined percentage of area being 30 percent.

5. The computer-implemented method as recited in claim 1, further comprising generating, at the advertisement detection system with the processor, a set of digital signature values corresponding to the first set of video fingerprints, wherein the generation of each digital signature value of the set of digital signature values being done by:
dividing each prominent frame of the one or more prominent frames into a pre-defined number of blocks, wherein each block of the pre-defined number of block having a pre-defined number of pixels;
grayscaling each block of each prominent frame of the one or more prominent frames;
calculating a first bit value and a second bit value for each block of the prominent frame, wherein the first bit value and the second bit value being calculated from comparing a mean and a variance for the pre-defined number of pixels in each block of the prominent frame with a corresponding mean and variance for a master frame in a master database; and
obtaining a 32 bit digital signature value corresponding to each prominent frame, wherein the 32 bit digital signature value being obtained by sequentially arranging the first bit value and the second bit value for each block of the pre-defined number of blocks of the prominent frame.

6. The computer-implemented method as recited in claim 5, wherein the first bit value and the second bit value being assigned a binary 0 when the mean and the variance for each block of the prominent frame being less the corresponding mean and variance of each master frame.

7. The computer-implemented method as recited in claim 5, wherein the first bit value and the second bit value being assigned a binary 1 when the mean and the variance for each block of the prominent frame being greater than the corresponding mean and variance of each master frame.

8. The computer-implemented method as recited in claim 1, wherein the unsupervised detection of the one or more advertisements being done by;
probabilistically matching a first pre-defined number of digital signature values corresponding to a pre-defined number of prominent frames of a real time broadcasted media content with a stored set of digital signature values present in a first database, wherein the probabilistic matching being performed for the set of digital signature values by utilizing a sliding window algorithm;
comparing one or more prominent frequencies and one or more prominent amplitudes of the extracted first set of audio fingerprints;
determining a positive probabilistic match of the pre-defined number of prominent frames based on a pre-defined condition;
fetching a video and an audio corresponding to the probabilistically matched digital signature values;
checking presence of the audio and the video manually in a master database; and
reporting a positively matched digital signature values corresponding to an advertisement of the one or more advertisements in a reporting database present in the first database.

9. The computer-implemented method as recited in claim 8, wherein the pre-defined condition comprises a pre-defined range of positive matches corresponding to the probabilistically matched digital signature values, a pre-defined duration of media content corresponding to the positive match, a sequence and an order of the positive matches and a degree of match of a pre-defined range of number of bits of the first pre-defined number of digital signature values.

10. The computer-implemented method as recited in claim 1, further comprising storing, at the advertisement detection system with the processor, the derived one or more characteristics associated with the one or more features associated with the channel, the first set of audio fingerprints, the first set of video fingerprints and the set of digital signature values corresponding to the first set of video fingerprints and wherein the storing being done in the first database and a second database.

11. The computer-implemented method as recited in claim 1, further comprising, updating, at the advertisement detection system with the processor, the derived one or more characteristics of the one or more features associated with each channel, the first set of audio fingerprints, the first set of video fingerprints and the set of digital signature values for the detected one or more advertisements in the master database.

12. The computer-implemented method as recited in claim 1, wherein the supervised detection of the one or more advertisements being done by:
probabilistically matching a second pre-defined number of digital signature values corresponding to a pre-defined number of prominent frames of a real time broadcasted media content with a stored set of digital signature values present in a master database, wherein the probabilistic matching being performed for the set of digital signature values by utilizing the sliding window algorithm;
comparing one or more prominent frequencies and one or more prominent amplitudes corresponding to the first set of audio fingerprints with a stored one or more prominent frequencies and a stored one or more prominent amplitudes; and
determining a positive match in the probabilistically matching of the second pre-defined number of digital signature values with the stored set of digital signature values in the master database and comparing of the one or more prominent frequencies and the one or more prominent amplitudes corresponding to the first set of audio fingerprints with the stored one or more prominent frequencies and the stored one or more prominent amplitudes.

13. A computer system comprising:
one or more processors; and
a memory coupled to the one or more processors, the memory for storing instructions which, when executed by the one or more processors, cause the one or more processors to perform a method for channel agnostic detection of television advertisements, the method comprising:
normalizing, at an advertisement detection system, each frame of a video corresponding to the broadcasted media content on each channel, wherein the normalization of each frame being done based on a histogram normalization and a histogram equalization and wherein the normalization of each frame being done by adjusting luminous intensity value of each pixel to a desired luminous intensity value;
deriving, at the advertisement detection system, one or more characteristics corresponding to one or more features associated with the media content broadcasted on each channel of a plurality of channels, wherein the one or more features associated with each channel comprises a logo associated with each channel and a ticker associated with each channel;
trimming, at the advertisement detection system, a pre-defined percentage of area in each frame of the media content based on the one or more characteristics corresponding to the one or more features associated with the media content;
extracting, at the advertisement detection system, a first set of audio fingerprints and a first set of video fingerprints corresponding to the media content broadcasted on each channel, wherein the first set of audio fingerprints and the first set of video fingerprints being extracted sequentially in real time, wherein the extraction of the first set of video fingerprints being done by sequentially extracting one or more prominent fingerprints corresponding to one or more prominent frames of a pre-defined number of frames present in the media content for a pre-defined interval of broadcast; and
detecting, at the advertisement detection system, one or more advertisements broadcasted across the plurality of channels in real time, wherein the one or more advertisements being detected based on at least one of a supervised detection and an unsupervised detection.

14. The computer system as recited in claim 13, wherein the one or more characteristics comprises a first set of characteristics associated with the logo of each channel and a second set of characteristics associated with the ticker associated with each channel, wherein the first set of characteristics comprises a pre-defined height of the logo, a pre-defined width of the logo and a pre-defined position of the logo and wherein the second set of characteristics comprises a pre-defined height of the ticker, a pre-defined width of the ticker and a pre-defined position of the ticker.

15. The computer system as recited in claim 13, wherein the pre-defined percentage of area in each frame being trimmed to a pre-defined scale and wherein the pre-defined scale of each frame being 640×480.

16. The computer system as recited in claim 13, wherein the pre-defined percentage of area being 30 percent.

17. The computer system as recited in claim 13, further comprising generating, at the advertisement detection system, a set of digital signature values corresponding to the first set of video fingerprints, wherein the generation of each digital signature value of the set of digital signature values being done by:
dividing each prominent frame of the one or more prominent frames into a pre-defined number of blocks, wherein each block of the pre-defined number of block having a pre-defined number of pixels;
grayscaling each block of each prominent frame of the one or more prominent frames;
calculating a first bit value and a second bit value for each block of the prominent frame, wherein the first bit value and the second bit value being calculated from comparing a mean and a variance for the pre-defined number of pixels in each block of the prominent frame with a corresponding mean and variance for a master frame in a master database; and
obtaining a 32 bit digital signature value corresponding to each prominent frame, wherein the 32 bit digital signature value being obtained by sequentially arranging the first bit value and the second bit value for each block of the pre-defined number of blocks of the prominent frame.

18. The computer system as recited in claim 17, wherein the first bit value and the second bit value being assigned a binary 0 when the mean and the variance for each block of the prominent frame being less than the corresponding mean and variance of each master frame.

19. The computer system as recited in claim 17, wherein the first bit value and the second bit value being assigned a binary 1 when the mean and the variance for each block of the prominent frame being greater than the corresponding mean and variance of each master frame.

20. A computer-readable storage medium encoding computer executable instructions that, when executed by at least one processor, performs a method for channel agnostic detection of television advertisements, the method comprising:
normalizing, at a computing device, each frame of a video corresponding to the broadcasted media content on each channel, wherein the normalization of each frame being done based on a histogram normalization and a histogram equalization and wherein the normalization of each frame being done by adjusting luminous intensity value of each pixel to a desired luminous intensity value;
deriving, at the computing device, one or more characteristics corresponding to one or more features associated with the media content broadcasted on each channel of a plurality of channels, wherein the one or more features associated with each channel comprises a logo associated with each channel and a ticker associated with each channel;
trimming, at the computing device, a pre-defined percentage of area in each frame of the media content based on the one or more characteristics corresponding to the one or more features associated with the media content;
extracting, at the computing device, a first set of audio fingerprints and a first set of video fingerprints corresponding to the media content broadcasted on each channel, wherein the first set of audio fingerprints and the first set of video fingerprints being extracted sequentially in real time, wherein the extraction of the first set of video fingerprints being done by sequentially extracting one or more prominent fingerprints corresponding to one or more prominent frames of a pre-defined number of frames present in the media content for a pre-defined interval of broadcast; and
detecting, at the computing device, one or more advertisements broadcasted across the plurality of channels in real time, wherein the one or more advertisements being detected based on at least one of a supervised detection and an unsupervised detection.
